(19) United States
(12) Patent Application Publication
(10) Pub. No.: US 2026/0340922 A1
(43) Pub. Date: Oct. 29, 2026

(54) MULTIMODAL CONDITIONING FOR IDENTITY-PRESERVING MOTION SYNTHESIS

(71) Applicant: Roblox Corporation, San Mateo, CA (US)

(72) Inventors: Yizhak BEN-SHABAT, Foster City, CA (US); Haomiao JIANG, Cupertino, CA (US); Joseph LIU, San Mateo, CA (US); Young Yoon LEE, San Mateo, CA (US); Victor B. ZORDAN, Riverside, CA (US); Mubbasir Turab KAPADIA, San Mateo, CA (US)

(73) Assignee: Roblox Corporation, San Mateo, CA (US)

(21) Appl. No.: 19/662,899

(22) Filed: Apr. 29, 2026

Related U.S. Application Data
(60) Provisional application No. 63/797,038, filed on Apr. 29, 2025.

(51) Int. Cl. G06T 13/40; G06F 40/40

(52) U.S. Cl. CPC G06T 13/40; G06F 40/40

(57) ABSTRACT

Identity-preserving motion sequences are generated for avatars in virtual environments. A motion sequence is synthesized by performing a denoising diffusion process conditioned on a motion content input and an identity profile that includes attributes such as body shape parameters, demographic traits, occupational characteristics, and class-based distinctions. A motion diffusion model performs a denoising diffusion process where the denoising diffusion process is initiated using a noise vector and iteratively generates respective denoised sets of video frames for each timestep and wherein each video frame in a respective denoised set of video frames includes a respective pose. Once it is determined that a termination criteria is met, a denoised set of video frames associated with the particular timestep are output as an identity-preserving motion sequence for the character. Separate encoding paths may be used for motion content and identity profile inputs to guide conditioning throughout the diffusion process.

### CROSS-REFERENCE TO RELATED APPLICATIONS

This application is a non-provisional application that claims priority under 35 U.S.C. § 119(e) to U.S. Provisional Patent Application No. 63/797,038, entitled “MULTIMODAL CONDITIONING FOR IDENTITY-PRESERVING MOTION SYNTHESIS,” filed on Apr. 29, 2025, the contents of which are hereby incorporated by reference herein in its entirety.

### TECHNICAL FIELD

Various embodiments described herein relate generally to motion generation for character, including avatars in virtual environments, and more particularly but not exclusively, relates to methods, systems, and computer-readable media to provide multimodal conditioning for generating identity-preserving motion sequences using one or more diffusion-based generative artificial intelligence models.

### BACKGROUND

Virtual experiences include characters that move within a virtual environment. The character movement (e.g., avatar movement) may be unrealistic due to limitations of character animation technology. For example, a character may make jerky movements instead of smooth movements that show sophisticated details (e.g., during a running motion, the joints of the arms and legs sway erratically, rather than moving in a natural pattern for the character). This issue may be exacerbated for characters that are other than human (or for characters with attributes that are far from a baseline character) because machine-learning models lack the training data to predict plausible movement for such characters. For example, mechanoid motion may be more difficult to simulate than human motion based on a paucity of examples of mechanoid motion.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A computer-implemented method comprises obtaining a motion content input that specifies a target motion sequence. The method further comprises obtaining an identity profile associated with a character. The method further comprises performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character. The method further comprises determining that a termination criteria for the denoising diffusion process is met at a particular timestep of the plurality of timesteps. The method further comprises responsive to determining that the termination criteria is met, outputting a denoised set of video frames associated with the particular timestep as an identity-preserving motion sequence for the character, wherein the identity-preserving motion sequence depicts the character performing the target motion sequence.

In some embodiments, wherein the motion content input comprises a natural language text prompt describing the target motion sequence. In some embodiments, performing the denoising diffusion process comprises identity-aware motion generation, where the identity-preserving motion sequence is generated to reflect a specific movement associated with the identity profile while maintaining consistency with the motion content input. In some embodiments, performing the denoising diffusion process comprises identity-conditioned motion generation and wherein the identity-preserving motion sequence is synthesized as an interpretation of the natural language text prompt that is constrained by the identity profile. In some embodiments, performing the denoising diffusion process comprises identity-conditioned motion generation, wherein the identity-preserving motion sequence is synthesized as an interpretation of the natural language text prompt that is constrained by a latent identity representation of the identity profile associated with the character.

In some embodiments, the motion content input comprises a sequence of input keyframe poses corresponding to a reference motion of a reference character, wherein the reference character is different from the character associated with the identity profile. In some embodiments, obtaining the identity profile includes receiving scalar input that specifies body shape parameters, receiving a body shape vector generated from a three-dimensional mesh of the character, receiving body shape parameters represented as a fixed-length vector of coefficients associated with a parametric body model of the character, or receiving a character description input that includes an image, a video, or a text description of the character that specifies one or more of demographic attributes, occupational attributes, class-based attributes, and combinations thereof. In some embodiments, the identity profile comprises semantic attributes extracted from one or more images or videos that depict the character. In some embodiments, the motion diffusion model comprises a transformer encoder configured to process encoded poses, positional encodings, and identity profile representations. In some embodiments, the identity profile is encoded using a multilayer perceptron and provided as a conditioning input at individual timesteps of the plurality of timesteps.

In some embodiments, respective poses in the denoised set of video frames are respective keyframe poses and the method further includes generating in-between motion frames that illustrate a transition between the respective keyframe poses and combining the denoised set of video frames with the in-between motion frames. In some embodiments, the motion content input and the identity profile are encoded independently of each other. In some embodiments, the motion content input that specifies the target motion sequence comprises a reference motion sequence of reference poses of a reference character depicting target motion, wherein the reference character is different from the character, performing the denoising diffusion process comprises identity-augmented motion generation, and the identity-preserving motion sequence includes a modification of the sequence of reference poses based on at least one physical or behavioral characteristic specified in the identity profile. In some embodiments, the motion diffusion model is trained based on a training dataset of reference motions of reference characters and identity profiles for each of the reference characters.

A system comprises one or more processors and a memory coupled to the one or more processors, with instructions stored thereon that, when executed by the one or more processors, cause the one or more processors to perform or control performance of operations. The operations comprise obtaining a motion content input that specifies a target motion sequence, obtaining an identity profile associated with a character, performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character, determining that a termination criteria for the denoising diffusion process is met at a particular timestep of the plurality of timesteps, and responsive to determining that the termination criteria is met, outputting a denoised set of video frames associated with the particular timestep as an identity-preserving motion sequence for the character, wherein the identity-preserving motion sequence depicts the character performing the target motion sequence.

In some embodiments, the motion content input comprises a natural language text prompt describing the target motion sequence. In some embodiments, performing the denoising diffusion process comprises identity-aware motion generation, wherein the identity-preserving motion sequence is generated to reflect a specific movement associated with the identity profile while maintaining consistency with the motion content input.

A non-transitory computer-readable medium with instructions stored thereon that, when executed by one or more computers, cause the one or more computers to perform or control performance of operations. The operations comprise obtaining a motion content input that specifies a target motion sequence, obtaining an identity profile associated with a character, performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character, determining that a termination criteria for the denoising diffusion process is met at a particular timestep of the plurality of timesteps, and responsive to determining that the termination criteria is met, outputting a denoised set of video frames associated with the particular timestep as an identity-preserving motion sequence for the character, wherein the identity-preserving motion sequence depicts the character performing the target motion sequence.

In some embodiments, the motion content input comprises a natural language text prompt describing the target motion sequence. In some embodiments, performing the denoising diffusion process comprises identity-aware motion generation, wherein the identity-preserving motion sequence is generated to reflect a specific movement associated with the identity profile while maintaining consistency with the motion content input.

### BRIEF DESCRIPTION OF DRAWINGS

FIG. 1 is a diagram of an example system architecture to provide multimodal conditioning for generating identity-preserving motion sequences using diffusion-based generative models, according to some embodiments.

FIG. 2 is a block diagram that illustrates an example computing device, according to some embodiments.

FIG. 3 is a block diagram that illustrates an example process for generating identity-preserving motion, according to some embodiments.

FIGS. 4A-4B are block diagrams that illustrates different examples of inputs and corresponding outputs that include identity-preserving motion, according to some embodiments.

FIG. 5 is a block diagram that illustrates an example method to create a training data of sets that include identity profiles paired with respective motion, according to some embodiments.

FIG. 6 is an architecture diagram that illustrates a motion diffusion model to generate identity-aware motion, according to some embodiments.

FIG. 7 is an architecture diagram that illustrates a motion diffusion model to generate identity-conditioned motion, according to some embodiments.

FIG. 8 is an architecture diagram that illustrates a motion diffusion model to generate identity-augmented motion, according to some embodiments.

FIG. 9 is a flow diagram of a method to generate identity-preserving motion, according to some embodiments.

### DETAILED DESCRIPTION

### Overview

Prior approaches to generating character motion (e.g., avatar motion) for virtual environments face significant limitations when dealing with diverse character identities. Motion generation models prioritize general movement patterns without regard for individual physical characteristics, demographic traits, or class-specific behaviors. Some artificial intelligence models generate motion outputs based on style overlays or emotion-driven variations, which results in characters moving in ways that may be physically implausible or inconsistent with their underlying identity. The lack of personalization (adaptation to character-specific attributes) can result in animations that fail to authentically reflect the attributes of different characters in gaming, simulation, or virtual reality environments.

Motion generation models, including diffusion-based architectures and recurrent networks, have demonstrated the ability to create diverse and realistic human motion based on textual descriptions, reference motion sequences, or random noise inputs. Such models generally condition on content alone. The models do not account for character-specific factors like body shape, size, or age, nor do they adapt motion based on the physical limitations or capabilities associated with different character classes. As a result, generated motion sequences may appear visually acceptable but fail to match the biomechanics, mass distribution, or expressive traits that are inherent to specific character types.

Some techniques attempt to retarget or stylize motion data by applying post-processing transformations, where generic motions are adapted to fit new character rigs or altered stylistically to convey emotions. Such post-processing approaches (which require additional computation after generating motion) do not modify the motion generation process itself based on identity characteristics. They map motion outputs after generation, resulting in artifacts such as velocity mismatches, broken physical constraints, and unnatural character behavior. Current approaches require large quantities of manually annotated motion capture data for each character type, which limits scalability and makes support for diverse virtual characters costly and labor-intensive.

Existing mechanisms for synthesizing or editing motion lack the ability to condition motion generation dynamically on multimodal identity inputs, such as body geometry, textual descriptions, visual references, and structured demographic data. The separation between motion content generation and identity-specific control introduces inefficiencies, reduces personalization, and increases the need for manual correction. The shortcomings hinder the scalability, flexibility, and realism of character animation in interactive experiences, particularly as virtual environments increasingly demand seamless support for heterogeneous character populations spanning, e.g., humans, fantasy beings, and mechanical constructs.

Various embodiments described herein perform identity-preserving motion synthesis that ensures a character's physical traits (e.g., their weight, height, and body type) dictate how they move. While conventional motion generation models often generate “generic” motion that looks the same regardless of character-specific attributes (e.g., whether it is applied to a lanky human or a heavy mechanoid), the embodiments described herein use a multimodal conditioning approach. By injecting an identity profile (e.g., comprising body shape, class traits, and/or physical attributes) into diffusion-based generation, various embodiments described herein produce animation that is not just a visual layer, but is physically consistent with the character's morphology.

Various embodiments relate to a motion diffusion model that operates over a series of discrete timesteps. Unlike techniques that apply motion styles as a post-processing step-which can result in velocity, the embodiments described herein estimate denoised keyframe poses at different stages of the generation process based on the target motion content and the identity profile. This deep integration allows the motion diffusion model to adapt biomechanical patterns, such as the lumbering gait of a heavy character versus the light-footed movement of a smaller one. Such adaptation can be realized in animation based on joint rotation and mass distribution of the character.

The techniques discussed herein enable identity-preserving motion synthesis for virtual characters by conditioning denoising diffusion on both motion content inputs and multimodal identity profiles. The identity profile (obtained and used with specific user permission) includes body shape parameters, demographic attributes, occupational characteristics, and/or class-based traits, which are encoded and provided alongside motion content at each diffusion timestep. A noise vector is sampled to initialize the motion sequence, and iterative updates are performed by estimating denoised keyframe poses conditioned on both content and identity information. Separate encoding branches may be used for motion content and identity features, enabling flexible augmentation and editing of motion sequences. The techniques enable physically consistent, character-authentic motion generation across a wide range of avatars, supporting diverse morphologies and identities within interactive virtual environments.

Various embodiments described herein provide several technical benefits. The described embodiments produce animations that have a high degree of realism (physical plausibility) by eliminating artifacts such as broken physical constraints and unnatural behavior that are common in motion retargeting. The techniques are scalable and computationally efficient and do not require manually annotated motion data for different character types (e.g., elves, orcs, robots). Instead, per embodiments described herein, motion synthesis can produce authentic motion for heterogeneous characters by adjusting the multimodal identity input. In addition, the training of the motion generation model is faster than previous models and achieves convergence.

The embodiments described herein allow virtual experience developers (e.g., game developers) to create diverse, realistic worlds where different characters move with a weight and style that is accurate to the character's attributes. For example, an older character has motion that automatically exhibits the stooped posture and slower gait inherent to their identity profile without requiring a specialized, hand-crafted animation set. Various embodiments provide improvement in the realism of character interactions.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be affected in connection with other embodiments whether or not explicitly described.

### System Architecture

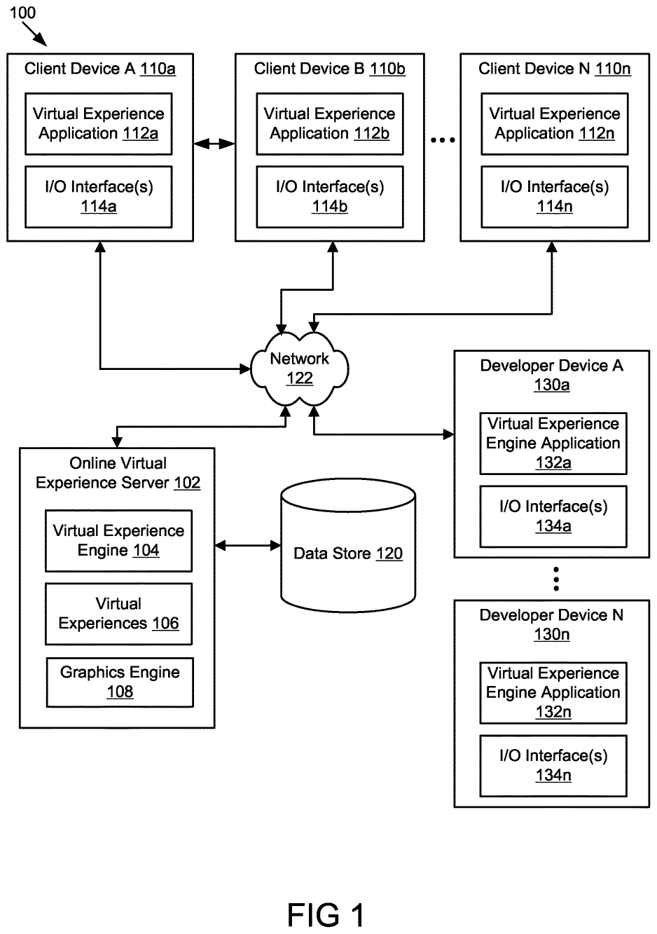

FIG. 1 is a diagram of an example system architecture that can be used to provide multimodal conditioning for generating identity-preserving motion sequences using diffusion-based generative models. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some embodiments, client device(s) 110 and developer device(s) 130 may refer to the same or same type of device.

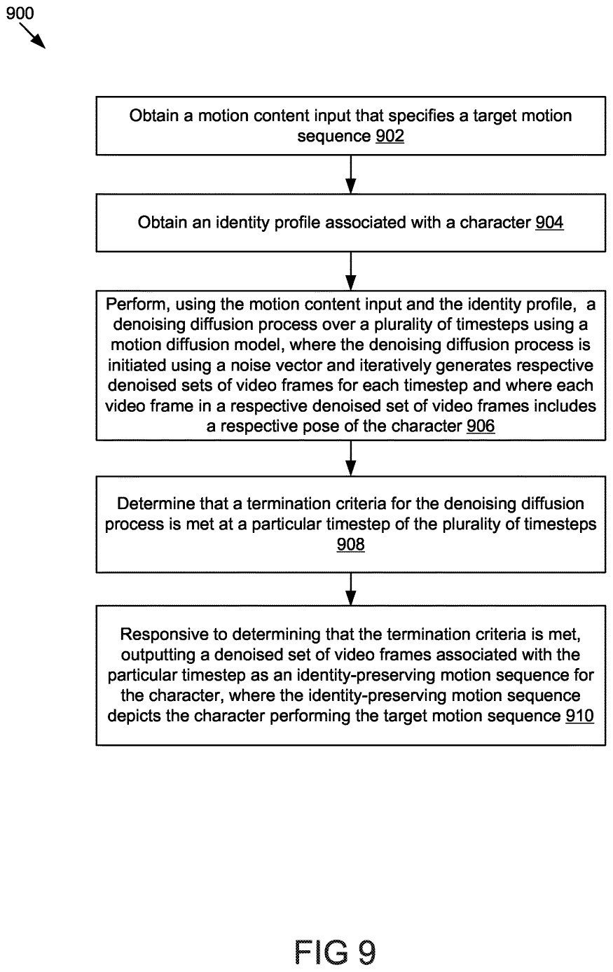

Online virtual experience server 102 can include, among other things, a virtual experience engine 104, one or more virtual experiences 106, and graphics engine 108. In some embodiments, the graphics engine 108 may be a system, application, or module that permits the online virtual experience server 102 to provide graphics and animation capability. In some embodiments, the graphics engine 108 is part of the virtual experience engine 104. In some embodiments, the graphics engine 108 may perform one or more of the operations described below in connection with the flowchart shown in FIG. 9. In one or more additional or alternative embodiments, the operations described below may be performed on one or more client devices 110, or one or more developer devices 130. In some embodiments, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different embodiments, the system architecture 100 may include the same, fewer, more, or different elements configured in the same or different manner as that shown in FIG. 1.

In some embodiments, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, and/or server computers.

In some embodiments, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some embodiments, data store 120 may include cloud-based storage.

In some embodiments, the online virtual experience server 102 can include a server having one or more computing devices (e.g., a cloud computing system, a rackmount server, a server computer, cluster of physical servers, etc.). In some embodiments, the online virtual experience server 102 may be an independent system, may include multiple servers, or be part of another system or server.

In some embodiments, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some embodiments, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some embodiments, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N: N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some embodiments of the disclosure, a “user” may be represented as a single individual. Other embodiments of the disclosure may include a “user” (e.g., creating user) being an entity controlled by a set of users or an automated source. For example, a set of individual users federated as a community or group in a user-generated content system may be considered a “user.”

In some embodiments, online virtual experience server 102 may be or include a virtual gaming server. For example, the gaming server may provide single-player or multiplayer games to a community of users that may access a “system” herein that includes the online virtual experience server 102, data store 120, and client device 110 and/or may interact with virtual experiences using client devices 110 via network 122. In some embodiments, virtual experiences (including virtual realms or worlds, virtual games, other computer-simulated environments) may be two dimensional (2D) virtual experiences, three dimensional (3D) virtual experiences (e.g., 3D user-generated virtual experiences), virtual reality (VR) experiences, or augmented reality (AR) experiences, for example. In some embodiments, users may participate in interactions (such as gameplay) with other users. In some embodiments, a virtual experience may be experienced in near-real-time with other users of the virtual experience.

In some embodiments, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some embodiments, a virtual experience 106 can include an electronic file that can be executed or loaded using software, firmware or hardware configured to present the virtual experience content (e.g., digital media item) to an entity. In some embodiments, a virtual experience application 112 may be executed and a virtual experience 106 rendered in connection with a virtual experience engine 104. In some embodiments, a virtual experience 106 may have a common set of rules or common goal, and the environment of a virtual experience 106 shares the common set of rules or common goal. In some embodiments, different virtual experiences may have different rules or goals from one another.

In some embodiments, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some embodiments, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some embodiments, users may buy, sell, or trade virtual experience objects, such as in-platform currency (e.g., virtual currency), with other users of the online virtual experience server 102. In some embodiments, online virtual experience server 102 may transmit virtual experience content to virtual experience applications (e.g., 112). In some embodiments, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some embodiments, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some embodiments, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some embodiments, a media item may be an electronic file that can be executed or loaded using software, firmware or hardware configured to present the digital media item to an entity.

In some embodiments, a virtual experience 106 may be associated with a particular user or a particular group of users (e.g., a private virtual experience) or made widely available to users with access to the online virtual experience server 102 (e.g., a public virtual experience). In some embodiments, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some embodiments, online virtual experience server 102 or client devices 110 may include a virtual experience engine 104 or virtual experience application 112. In some embodiments, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some embodiments, virtual experience applications 112 of client devices 110, respectively, may work independently, in collaboration with virtual experience engine 104 of online virtual experience server 102, or a combination of both.

In some embodiments, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some embodiments, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some embodiments, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some embodiments, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some embodiments, the control instructions are sent directly to the online virtual experience server 102. In other embodiments, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some embodiments, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some embodiments, characters (or virtual experience objects generally) are constructed from components, one or more of which may be selected by the user, that automatically join together to aid the user in editing.

In some embodiments, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate an interaction of the user with the virtual experience 106.

In some embodiments, a character may include components such as body parts (e.g., hair, arms, legs, etc.) and accessories (e.g., t-shirt, glasses, decorative images, tools, etc.). In some embodiments, body parts of characters that are customizable include head type, body part types (arms, legs, torso, and hands), face types, hair types, and skin types, among others. In some embodiments, the accessories that are customizable include clothing (e.g., shirts, pants, hats, shoes, glasses, etc.), weapons, or other tools.

In some embodiments, for some asset types, e.g., shirts, pants, etc. the online virtual experience platform may provide users access to simplified 3D virtual object models that are represented by a mesh of a low polygon count, e.g., between about 20 and about 30 polygons.

In some embodiments, the user may control the scale (e.g., height, width, or depth) of a character or the scale of components of a character. In some embodiments, the user may control the proportions of a character (e.g., blocky, anatomical, etc.). It may be noted that in some embodiments, a character may not include a character virtual experience object (e.g., body parts, etc.) but the user may control the character (without the character virtual experience object) to facilitate the interaction of the user with the virtual experience (e.g., a puzzle game where there is no rendered character game object, but the user still controls a character to control in-game action).

In some embodiments, a component, such as a body part, may be a primitive geometrical shape such as a block, a cylinder, a sphere, etc., or some other primitive shape such as a wedge, a torus, a tube, a channel, etc. In some embodiments, a creator module may publish a character of a user for view or use by other users of the online virtual experience server 102. In some embodiments, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some embodiments, the online virtual experience server 102 may store characters created by users in the data store 120. In some embodiments, the online virtual experience server 102 maintains a character catalog and virtual experience catalog that may be presented to users. In some embodiments, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some embodiments, one or more of the characters in the character catalog may have been created or customized by the user. In some embodiments, the chosen character may have character settings defining one or more of the components of the character.

In some embodiments, a character of a user can include a configuration of components, where the configuration and appearance of components and more generally the appearance of the character may be defined by character settings. In some embodiments, the character settings of a character of a user may at least in part be chosen by the user. In other embodiments, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some embodiments, the client device(s) 110 may each include computing devices such as personal computers (PCs), mobile devices (e.g., laptops, mobile phones, smart phones, tablet computers, or netbook computers), network-connected televisions, gaming consoles, etc. In some embodiments, a client device 110 may be referred to as a “user device.” In some embodiments, one or more client devices 110 may connect to the online virtual experience server 102 at any given moment. It may be noted that the number of client devices 110 is provided as illustration. In some embodiments, any number of client devices 110 may be used.

In some embodiments, each client device 110 may include an instance of the virtual experience application 112, respectively. In one embodiment, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an embodiment, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some embodiments, each developer device 130 may include an instance of the virtual experience application 132, respectively. In one embodiment, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an embodiment, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some embodiments, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some embodiments, with appropriate credentials, a virtual experience developer may obtain access to virtual experience virtual objects, such as in-platform currency (e.g., virtual currency), avatars, special powers, accessories, which are owned by or associated with other users.

In general, functions described in one embodiment as being performed by the online virtual experience server 102 can be performed by the client device(s) 110, or a server, in other embodiments if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

### Computing Device

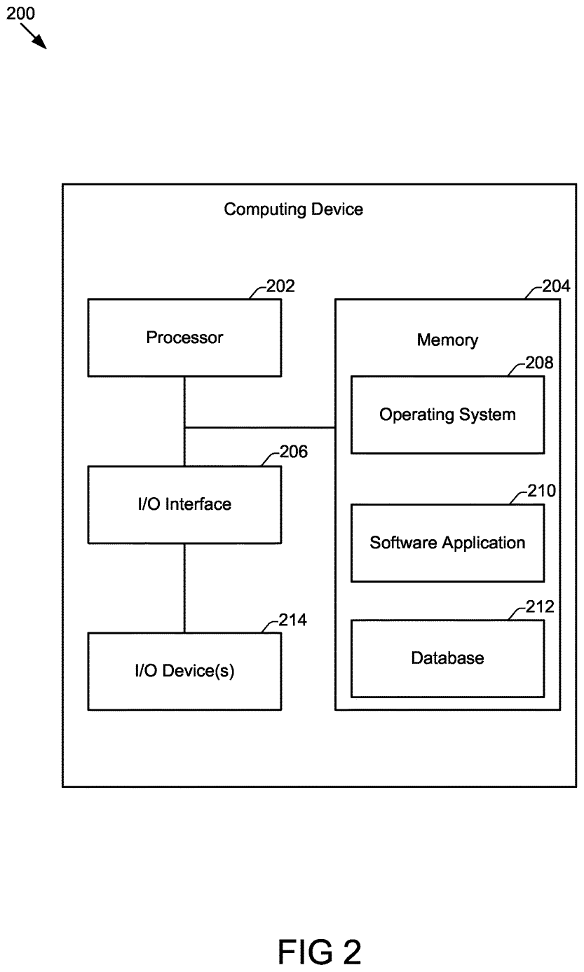

FIG. 2 is a block diagram of an example computing device 200 which may be used to implement one or more techniques described herein. In one example, device 200 may be used to implement a computer device (e.g., 102 and/or 110 of FIG. 1), and perform appropriate method embodiments described herein. Computing device 200 can be any suitable computer system, server, or other electronic or hardware device. For example, the computing device 200 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some embodiments, device 200 includes a processor 202, a memory 204, input/output (I/O) interface 206, and audio/video input/output devices 214.

Processor 202 can be one or more processors and/or processing circuits to execute program code and control basic operations of the device 200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 204 is provided in device 200 for access by the processor 202, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 202 and/or integrated therewith. Memory 204 can store software operating on the computing device 200 by the processor 202, including an operating system 208, one or more applications 210, and a database 212 that may store data used by the components of device 200.

Database 212 may store one or more mechanisms, including identity profile data and motion conditioning parameters for enabling identity-preserving motion generation in a virtual environment. In some embodiments, database 212 may store information associated with avatars, such as avatar identifiers, body shape parameters, demographic attributes, occupational classifications, and class-based traits used for motion synthesis conditioning. The stored data can include encoded identity representations, motion content inputs such as text prompts or keyframe pose sequences, and configuration parameters used to guide diffusion-based motion generation. For example, in a multiplayer gaming environment, the database might store avatar metadata including body morphology type, age category, and occupation label to enable generation of motion sequences that are physically consistent with each avatar. In some embodiments, database 212 may store other data relevant to motion generation, such as conditioning branch weights, thresholds for identity influence during diffusion, and runtime performance logs used to adapt generation behavior. In some embodiments, applications 210 can include instructions that enable processor 202 to execute the described techniques, such as encoding identity profiles, conditioning motion diffusion on multimodal inputs, and generating identity-preserving motion sequences.

For example, applications 210 can include a module that implements one or more algorithms or services used in the techniques described herein, such as multimodal identity profile encoding, motion content embedding, and conditioning-based diffusion for motion synthesis. Applications 210 can integrate real-time updates that monitor avatar identity profiles and motion content inputs, enabling motion generation to adapt responsively when avatar attributes change or when new content prompts are received. The applications may employ various mechanisms to provide motion generation efficiently, including prioritizing avatars based on activity level, caching previously generated motion sequences, and scheduling motion updates within runtime frame time constraints. Database 212 (and/or other connected storage) can store various data used in the described techniques, including avatar metadata, historical motion content inputs, cached identity-conditioned motion outputs, identity encoding cache entries, and parameters used to determine whether a motion sequence is to be newly generated or adapted from an existing cached version.

Elements of software in memory 204 can alternatively be stored on any other suitable storage location or computer-readable medium. In addition, memory 204 (and/or other connected storage device(s)) can store instructions and data used in the features described herein. Memory 204 and any other type of storage (magnetic disk, optical disk, magnetic tape, or other tangible media) can be considered “storage” or “storage devices.”

I/O interface 206 can provide functions to enable interfacing the computing device 200 with other systems and devices. For example, network communication devices, storage devices (e.g., memory and/or data store 120), and input/output devices can communicate via interface 206. In some embodiments, the I/O interface can connect to interface devices including input devices (keyboard, pointing device, touchscreen, microphone, camera, scanner, etc.) and/or output devices (display device, speaker devices, printer, motor, etc.).

The audio/video input/output devices 214 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 2 shows one block for each of processor 202, memory 204, I/O interface 206, and software blocks of operating system 208 and virtual experience application 210. The blocks may represent one or more processors or processing circuitries, operating systems, memories, I/O interfaces, applications, and/or software engines. In other embodiments, device 200 may not have all of the components shown and/or may have other elements including other types of elements instead of, or in addition to, those shown herein. While the online virtual experience server 102 is described as performing operations as described in some embodiments herein, any suitable component or combination of components of online virtual experience server 102, client device 110, or similar system, or any suitable processor or processors associated with such a system, may perform the operations described.

Device 200 can be a server device or client device. Example client devices or user devices can be computer devices including some similar components as the device 200, e.g., processor(s) 202, memory 204, and I/O interface 206. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 214, for example, can be connected to (or included in) the device 200 to display images pre- and post-processing as described herein, where such display device can include any suitable display device, e.g., an LCD, LED, or plasma display screen, CRT, television, monitor, touchscreen, 3-D display screen, projector, or other visual display device. Some embodiments can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular embodiments thereof, the particular embodiments are merely illustrative, and not restrictive. Concepts illustrated in the examples may be applied to other examples and embodiments.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular embodiments. Different programming techniques may be employed, e.g., procedural or object-oriented. The routines may execute on a single processing device or multiple processors. Although the steps, blocks, operations, or computations may be presented in a specific order, the order may be changed in different particular embodiments. In some embodiments, multiple steps or operations shown as sequential in this specification may be performed at the same time.

### Multimodal Conditioning for Generating Identity-Preserving Motion Sequences

Various embodiments described herein relate to generating identity-preserving motion sequences for virtual avatars such as characters (e.g., avatars) that may be associated with users participating in a virtual environment, non-playing characters (NPCs) whose behavior is controlled by the virtual environment platform, and/or other characters, by conditioning a denoising diffusion process on multimodal identity profiles and motion content inputs. As used herein, identity refers to a collection of attributes of an avatar that influence the movement patterns and physical behavior of the avatar. Identity encompasses enduring (or on occasion, transient, such as a hand temporarily tied behind the back) physical and semantic attributes of an avatar but also style, which refers to transient expressions or emotional states that may alter motion temporarily without changing the underlying characteristics of the avatar. For example, an avatar with a heavy build and a lumbering gait retains the identity-driven movement traits whether walking happily or sadly, while the emotional tone reflected in the gait represents the style.

An identity profile may include user-permitted attributes such as, e.g., body shape parameters, demographic information, occupational characteristics, and/or class-based features describing the physical form and behavior traits of the avatar. In some embodiments, body shape parameters may be derived from statistical body models, such as a set of shape coefficients associated with human morphology. In some embodiments, demographic or semantic attributes may be extracted (with appropriate permissions, and in compliance with applicable regulations) from images or videos using vision-language models to enrich the identity profile. Motion content inputs may include text prompts (e.g., in natural language) describing target motion behaviors or sequences of reference poses representing partial motions. Identity and motion content are encoded separately and combined as conditioning inputs to guide the generation during individual timestepsw of the diffusion sequence.

Rather than generating motion solely based on style overlays or generic templates, the described techniques estimate denoised motion representations at individual diffusion timesteps (also referred to as timesteps) using both the current noisy motion input and the encoded identity profile and motion content. A noise vector is sampled to initialize the motion sequence, and iterative updates refine the character motion toward the desired identity-preserving behavior. In some embodiments, the identity profile is encoded using a multilayer perceptron (MLP), and conditioning vectors are fused with pose representations and positional encodings during transformer-based diffusion updates. By updating noisy motion representation based on both content (type of motion) and identity (of the character) at each timestep, the described techniques enable synthesis of motion that is physically plausible (realistic), character-consistent, and adapted to diverse avatar morphologies and behaviors. Additionally, by enabling separate encoding of motion content and identity profiles, the techniques support flexible generation and augmentation of motion sequences for heterogeneous character populations in virtual environments.

According to one aspect to provide multimodal conditioning for generating identity-preserving motion sequences, a motion content input specifying a target motion sequence is obtained. An identity profile associated with a character is obtained, the identity profile including one or more from the following group: body shape parameters, demographic attributes, occupational attributes, or class-based characteristics. A motion input is generated by sampling a noise vector. Denoising diffusion is performed over a series of timesteps, where at each timestep: a denoised set of keyframe poses is estimated, using a machine-learned diffusion model, based on the motion input, the motion content input, the identity profile, and a current timestep; the motion input is updated based on the denoised set of keyframe poses and the current timestep; and the timestep is decremented. The estimating, updating, and decrementing are repeated (with each iteration providing inputs to the next) until the timestep reaches a terminal value (or another termination criterion is satisfied). A final set of keyframe poses is outputted as an identity-preserving motion sequence.

### Identity Preserving Motion

In some embodiments, the graphics engine 108 illustrated in FIG. 1 includes a motion diffusion model that is trained to receive motion content input and an identity profile and output identity preserving motion. An image diffusion model is trained to receive a noise vector and perform a diffusion process that iteratively performs denoising to generate a structured output. For example, a diffusion model may receive an input image, a textual request, and a noise vector and generate an output image based on the input image that satisfies the textual request.

In the context of a motion diffusion model, the “noise” is unpredictable motion. A motion diffusion model generates output motion by iteratively removing unpredictable motion from a series of frames such that the output progressively changes from unpredictable motion to predictable motion. For example, if a motion diffusion model receives a request for a character that is performing a jumping jack, the initial output performs movements that are erratic and that have nothing to do with performing a jumping jack. As the diffusion process continues, the motion progressively conforms to a character performing the jumping jack.

Motion diffusion models are trained to generate motion for characters that look like an average-built human. The motion depiction is less accurate when the character deviates from the average. For example, a character with a large stomach or extremely muscular arms in reality moves differently from the average-built human. This problem is exacerbated when the character is not human (as many characters in games or virtual experience are) or has exaggerated attributes while retaining human form. For example, an orc has different physical constraints, capabilities, learned patterns, and characteristic expressions than the average-built human. The process of ensuring that input provided to the motion diffusion model is reflected in the character and the motion output by a motion diffusion model is referred to as identity-preserving motion. Identity-preserving motion maintains the unique facial features, clothing, and body proportions consistently across a set of video frames.

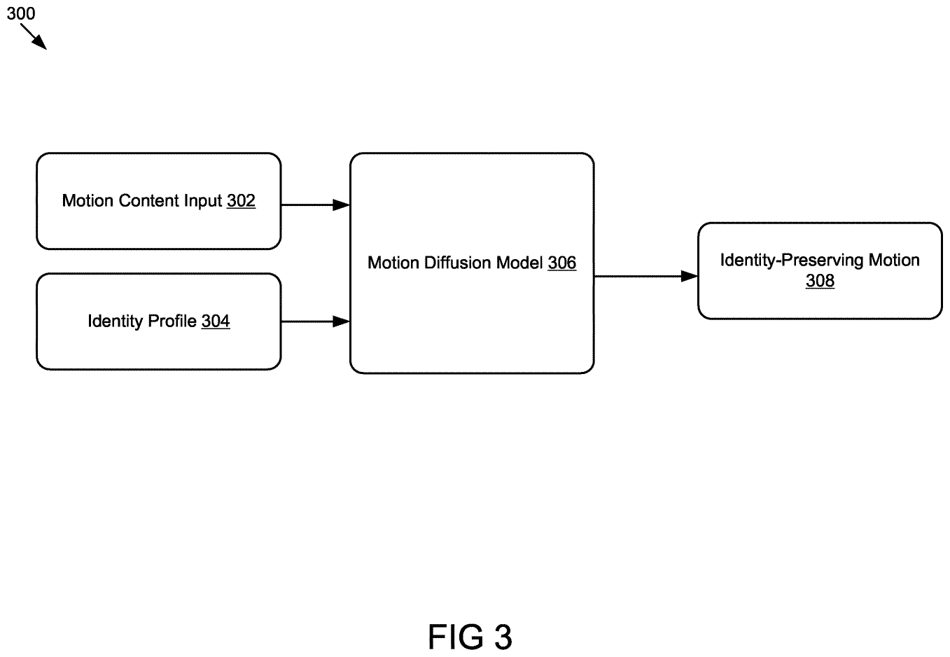

FIG. 3 is a block diagram 300 that illustrates an example process for generating identity-preserving motion, according to some embodiments. The block diagram 300 includes a motion diffusion model 306 that receives motion content input 302 and an identity profile 304.

The motion content input 302 includes instructions for a type of motion to be output by the motion diffusion model 306. In some embodiments, the motion content input 302 is multimodal and includes input text that is descriptive of a target motion (e.g., a natural language text prompt), an image that reflects the target motion, a video (e.g., an animation, a motion sequence, a sequence of input keyframe poses corresponding to a reference motion, etc.) that depicts the target motion, and/or audio. For example, the motion content input 302 may include a textual request (e.g., received from a user) for “a person jogging,” an image of a person mid stride during a jog, a video of the person jogging, and/or audio describing “a person jogging.”

In some embodiments, the motion content input 302 includes style, which includes motion characteristics that convey personality and/or temper/emotional state. Style may include a state of mind of the character (e.g., happy, sad, or angry). For example, a character may throw a ball playfully by having a longer arm motion while smiling. Conversely, a character may throw a ball angrily by having a shorter arm motion while frowning.

In some embodiments, the graphics engine 108 illustrated in FIG. 1 includes a user interface module that generates examples of different types of motions that a user may select for the motion content input 302. For example, the user interface module may generate a user interface with different pre-configured options for types of motions. The options may include textual descriptions of different motions, videos of different motions, a selectable button for initiating an audio recording where a user may provide instructions, etc. The user interface may include a search bar where a user may input a textual description and/or an audio description that is used to search for matching examples of motion.

The identity profile 304 is associated with a character. The identity profile 304 may include a textual description of the character; an image of the character; a reference to the character itself, such as a 3D model file (e.g., a .vrm or .fbx file); and/or a body shape vector generated from a 3D mesh of the character (e.g., body shape parameters, a parametric body model, etc.). In some embodiments, the identity profile 304 includes shape parameters of the character (e.g., height, weight, proportions, male/female, human, humanoid, non-humanoid character, feral character, etc.), physical characteristics (e.g., age, hairstyle, eye color, etc.), character class (e.g., occupation, such as dancer, athlete, construction worker; stylistic guidance, such as energetic, etc.), species/race (elf, human, orc, alien, etc.), and/or physical abilities (e.g., disabilities, super-abilities, etc.). The textual description may include scalar input that specifies body shape parameters or a description that specifies demographic attributes, occupational attributes, and/or class-based characteristics. In some embodiments, the identity profile 304 includes semantic attributes extracted from one or more images or videos depicting the character. For example, the semantic attributes may be generated using a vision-language model to summarize the shape parameters, character class, and/or physical abilities of the character. In some embodiments, the identity profile 304 includes body shape parameters represented as a fixed-length vector of coefficients associated with a parametric body model of the character.

The motion content input 302 and the identity profile 304 may be provided to the motion diffusion model 306 during creation of a character (e.g., an avatar). For example, a user may select a particular character and may specify different motions that the user wants the character to be able to perform.

In some embodiments, the motion content input 302 and the identity profile 304 may be provided to the motion diffusion model 306 in real-time while a virtual experience is ongoing. For example, a user may control a character in a virtual experience and encounter a situation where the character does not perform a particular motion that would be helpful for achieving a goal in the virtual experience. The graphics engine 108 may generate a user interface that allows the user to specify a particular motion. The motion diffusion model 306 may output the identity-preserving motion 308 and a user interface module may add the identity-preserving motion 308 as an option for the character to perform. The identity-preserving motion 308 is a motion sequence, such as a video or an animation.

The motion diffusion model 306 outputs identity-preserving motion 308 based on the motion content input 302 and the identity profile 304 to provide a motion sequence for a character that matches the identity profile 304. The motion diffusion model 306 may support any of three different incorporations of character identity into the generated motion: identity-aware motion, identity-conditioned motion, or identity-augmented motion. In the identity-aware embodiment, the motion diffusion model 306 generates the identity-preserving motion 308 while indirectly incorporating the identity profile. In the identity-conditioned embodiment, the identity-preserving motion 308 is controlled directly using the identity profile 304 but not directly using the motion content input 302. In the identity augmented embodiment, full control on both the motion content input 302 and the identity profile 304 is exerted to generate the identity-preserving motion 308. In some embodiments, the identity-augmented embodiment uses motion content input 302 that includes a motion sequence (e.g., a video/animation) and uses the motion content input 302 to directly control the identity-preserving motion 308.

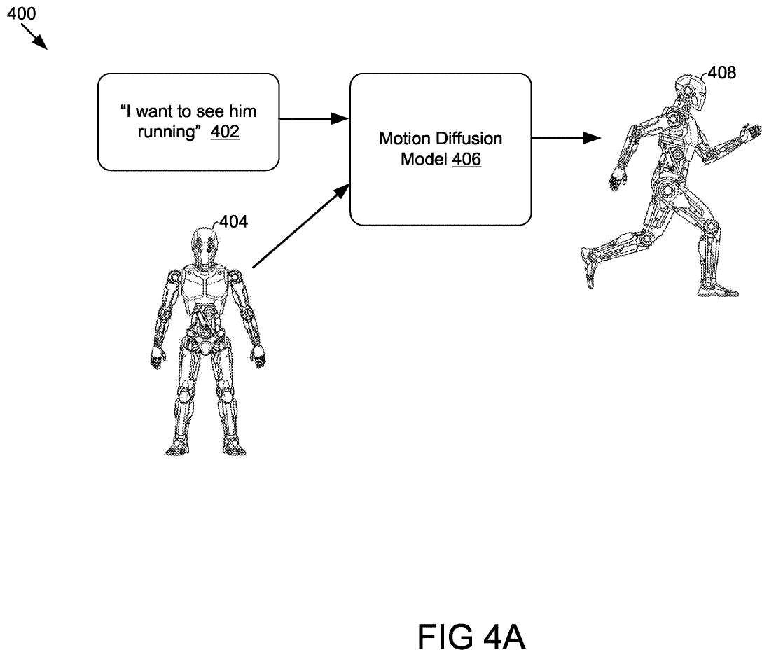

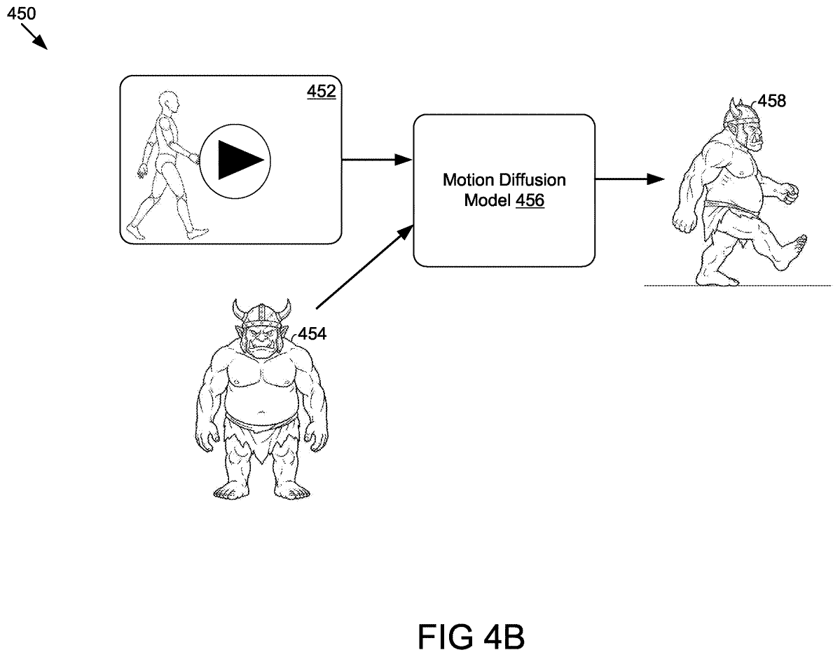

FIGS. 4A-4B are block diagrams 400, 450 that illustrate different examples of inputs that are used by a diffusion model to generate outputs that include the identity-preserving motion 308 from FIG. 3, according to some embodiments. Turning to FIG. 4A, a motion diffusion model 406 receives motion content input that includes a textual request: “I want to see him running” 402 and an identity profile that includes an image of a mechanoid character 404. The motion diffusion model 406 generates identity-preserving motion that includes a set of video frames of the mechanoid running 408. The mechanoid in the set of video frames of the mechanoid running 408 matches the identity profile. For example, the mechanoid moves with rigid mechanical actuators and gears, resulting in a stiffer, more calculated gait as compared to the flexible, energy-efficient, and complex muscle-coordinated movement of humans.

Turning to FIG. 4B, a motion diffusion model 456 receives motion content input that includes a video 452 of a person walking in a circle and an identity profile that includes a 3D model file and body parameters of a character 454 where the character is an ogre. The motion diffusion model 456 generates identity-preserving motion that includes a set of video frames of the ogre walking in a circle 458. For example, the ogre moves with a more lumbering gait with hard footfalls than a human. In addition, because the identity profile includes an age of an older ogre, the ogre moves slowly with a slightly-stooped posture (rather than at a higher speed and straight posture that would be associated with a young ogre) to indicate that the ogre's movement is affected by his age.

### Training Data for a Motion Diffusion Model

In various embodiments, the motion diffusion model is trained using paired identity profiles and motion for reference characters where the motion represents ground truth data. A problem exists where there are not enough examples of training data available that represent diversity of body shapes, especially when it comes to humanoid and non-human characters. The technology described herein advantageously solves this problem by creating training data from videos obtained and used in accordance with applicable regulation, and with specific licenses from data providers.

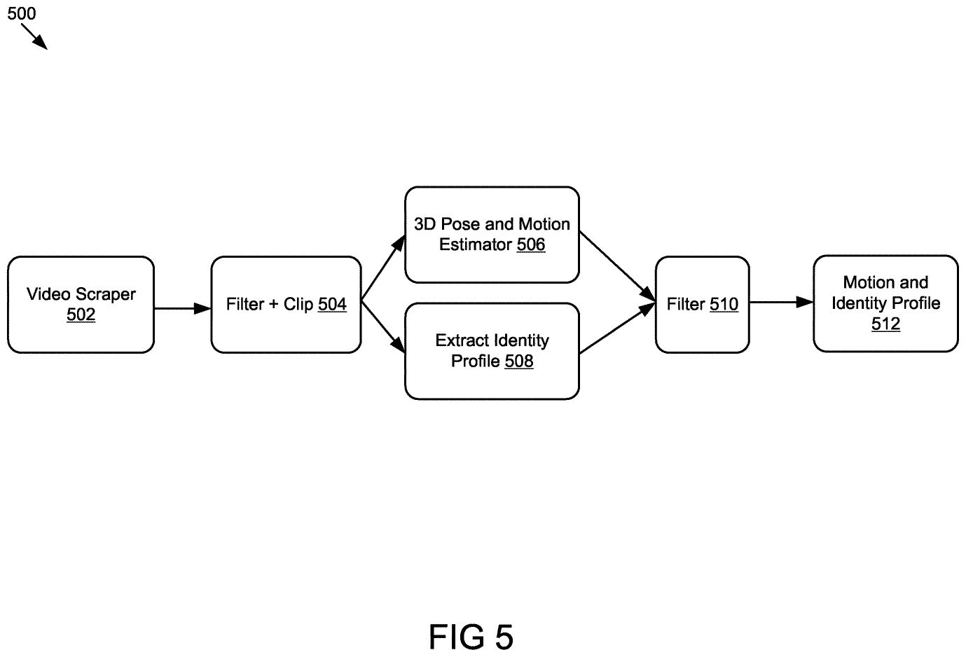

FIG. 5 is a block diagram 500 that illustrates an example method to create a training data of sets that include identity profiles paired with respective motion sequences, according to some embodiments. The steps may be performed by the graphics engine 108 illustrated in FIG. 1. At block 502, a video scraper identifies videos from available videos that are permitted for use for model training that depict motion. In some embodiments, the videos are identified using queries, such as videos of different types of characters that are in motion (e.g., elves, orcs, mechanoids, animals, humans, etc.). The queries may include identification of characters and/or identification of characters performing particular motions. In some embodiments, the query is supplemented with suggested search terms from a large language model (LLM). The videos may be raw videos obtained from different video platforms that make videos available for training of artificial intelligence models (with appropriate licenses and permissions from video creators). Block 502 may be followed by block 504.

At block 504, the videos identified by the video scraper are filtered and clipped. In some embodiments, filtering and clipping includes removing noisy frames where a character is not moving, removing frames where the character is not in the frame, etc.

In some embodiments, a CLIP score is calculated for each video, where the CLIP score reflects how well the video aligns with the query. For example, the query may be converted to a query embedding, the video may be converted to a video embedding, and the CLIP score may indicate cosine similarity between the query embedding and the video embedding. Videos may be selected for processing that meet a threshold CLIP score. In some embodiments, one video may be filtered and clipped in different ways and a version of the video with the best CLIP score is selected. Block 504 may be followed by block 506.

At block 506, 3D pose and motion estimation is performed on the selected videos. In some embodiments, performing 3D pose and motion estimation includes identifying keyframes from the selected videos that represent joints and rotations of characters in the videos.

At block 508, identity profiles are extracted from the selected videos. Block 508 may be performed in parallel with block 506 or sequentially before or after block 506. In some embodiments, extracting the identity profiles includes extracting body shape parameters from the selected videos. In some embodiments, a vision-language model (VLM) is used to extract additional aspects of the identity profile, such as summaries of the contents of the selected videos. Block 508 may be followed by block 510.

At block 510, pairs of motion sequences and identity profiles are filtered (e.g., excluded) if the motion sequences are identified as including low-quality motion and/or the identity profiles with threshold level of uncertainty. The motion sequences that depict low-quality motion or identity profiles that have threshold level of uncertainty may be excluded from being used in the training data (or may be included with indications of the quality/uncertainty, and/or included with a low weight, where the weights are utilized during model training). Block 510 may be followed by block 512.

At block 512, training data is generated from pairs of motion sequences and identity profiles that were not excluded at block 510.

### Motion Diffusion Model Architecture

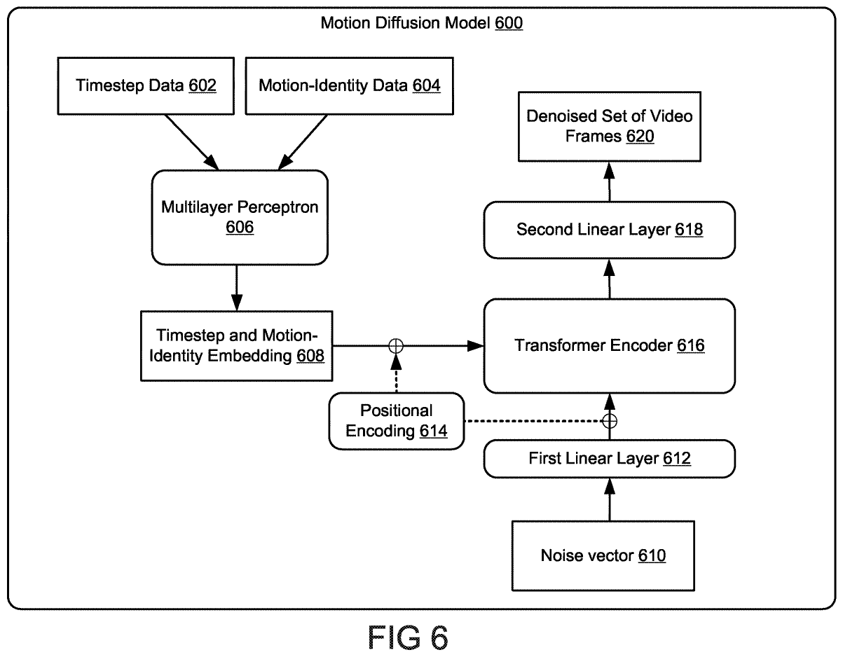

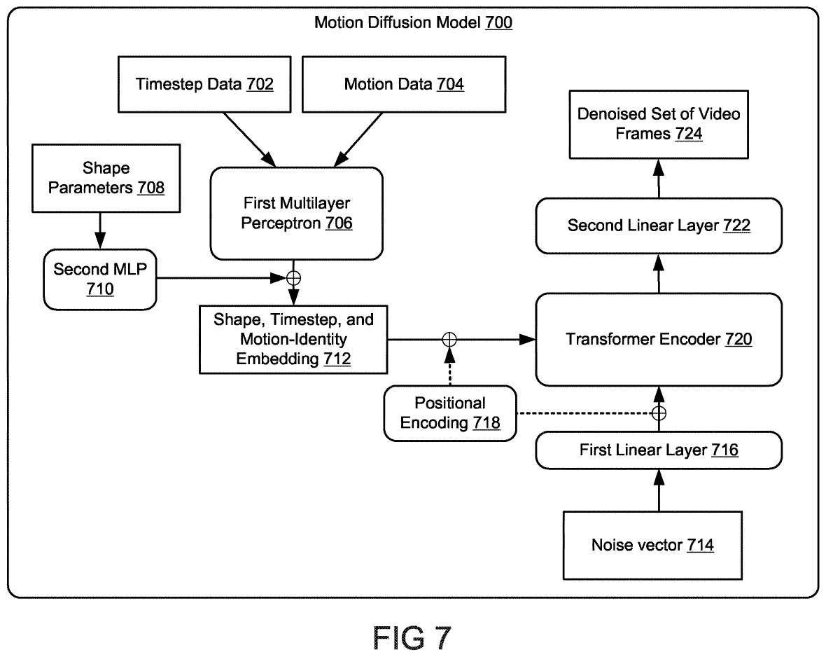

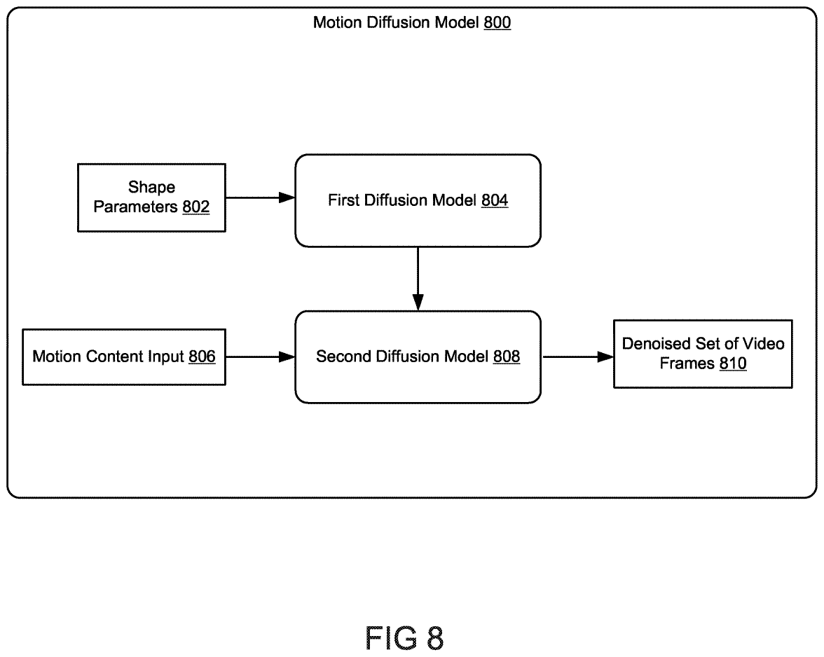

In various embodiments, the motion diffusion model may have different architectural forms based on the use case for the motion diffusion model. FIG. 6 is an example architecture for a motion diffusion model that generates identity-aware motion, FIG. 7 is an example architecture for a motion diffusion model that generates identity-conditioned motion, and FIG. 8 is an example architecture for a motion diffusion model that generates identity-augmented motion. Different combinations of components of these architectures may be used for the motion diffusion model depending on the use case, available inputs, computational budgets, and/or other factors.

FIG. 6 is an architecture diagram that illustrates a motion diffusion model 600 to generate identity-aware motion, according to some embodiments. The motion diffusion model 600 for identity-aware motion generates motion and a shape while incorporating a shape profile.

The motion diffusion model 600 includes a multilayer perceptron 606 that receives timestep data (t) 602 and motion-identity data (k) 604. Timestep data 602 describes information about the diffusion process to be performed by the transformer encoder 616 over discrete steps (e.g., between 50 and 1000 steps depending on the diffusion model). The motion-identity data 604 includes motion content input and an identity profile associated with a character.

The motion content input specifies a target motion. The motion content input may include textual instructions (e.g., “make the character drink coffee”), audio instructions (e.g., audio stating “make the character drink coffee”), an image (e.g., an image of a person holding a coffee cup), and/or a video (e.g., a video of a person drinking from a coffee cup). In some embodiments, the motion content input includes multiple data items, such as the textual instructions “make the character drink coffee” and a video of a person drinking from a cup.

In some embodiments, the video may include keyframes of a person. For example, a first keyframe may be of a person holding a cup, a second keyframe may be of a person moving an arm toward the person's face while holding the cup, and a third keyframe may be the person with the cup touching their lips. The keyframes may be represented by joint rotations, join positions, and/or or point clouds depending on the type of motion. For example, the keyframes may include joint rotations if the motion includes rotation or twisting of a body part (e.g., arm, leg, torso, etc.). In some embodiments, the keyframes may be associated with pose parameters (0) that are scalar values that describe the rotations of different joints.

In some embodiments, the identity profile is a character (e.g., avatar) created by a user for a virtual experience. The identity profile may include a textual description of the character, an image of the character, a reference to the character itself, and/or shape parameters of the character.

A multilayer perceptron 606 is a feed-forward neural network that includes an input layer, one or more hidden layers, and an output layer. In some embodiments, the multilayer perceptron 606 generates a timestep embedding from the timestep data 602 and a motion-identity embedding from the motion-identity data 604. The timestep embedding is a numerical representation of how each timestep corresponds to a stage where the transformer encoder 616 progressively removes noise from the input (e.g., which, for a first diffusion timestep, includes a noise vector 610, and for subsequent diffusion timesteps, includes the output from a previous timestep).

The multilayer perceptron 606 combines the timestep embedding and motion-identity embedding to form a timestep and motion-identity embedding (Zₜₖ) 608 where Zₜₖ refers to the combination of the timestep embedding (t) and an index (k) for the motion-identity embedding. In some embodiments, a separate multilayer perceptron (not shown) may be used to generate the motion-identity data embedding. For example, a pre-trained encoder (e.g., contrastive language-image pre-training (CLIP) for text data) may generate the motion-identity embedding from the motion-identity data 604. In some embodiments, a separate linear layer (not shown) may be used to modify the dimensionality of the motion-identity embedding (e.g., for compatibility with the transformer encoder 616) before it is received by the multilayer perceptron 606.

The timestep and motion-identity embedding 608 represents a latent representation of the motion-identity data at respective timesteps. In some embodiments, the multilayer perceptron 606 generates the timestep and motion-identity embedding 608 by concatenating the timestep embedding and the motion-identity embedding. In some embodiments, the multilayer perceptron 606 generates the timestep and motion-identity embedding 608 by projecting the embeddings into a shared, different-dimensional space (e.g., low-dimensional space or high-dimensional space).

The timestep and motion-identity embedding 608 is provided as input to the transformer encoder 616 and servers to indicate the correspondence of a particular timestep corresponds to a particular motion during the denoising process. For example, the motion-identity data 604 may include a video of five keyframes that represent important poses for achieving a particular type of motion.

At a first diffusion timestep, a first linear layer 612 receives a noise vector 610 as input from length 1 to

$$N ( {x}_{t}^{1} … {x}_{t}^{N} )$$

where N corresponds to the number of video frames to be output. In some embodiments, the noise vector 610 is sampled from a normal distribution (a Gaussian distribution). In some embodiments, the noise vector 610 is a tensor that includes one or more of the number of joints and/or the number of degrees of freedom (for the character), and the number of timesteps.

The first linear layer 612 projects the noise vector 610 into a higher-dimensional embedding space for the transformer encoder 616 where the number of dimensions of the projected noise vector matches the number of dimensions for the timestep and motion-identity embedding 608. The output from the first linear layer 612 is combined with the output of the timestep and motion-identity embedding 608 at a conditioning injection point with a positional encoding 614 and provided as input to the transformer encoder 616. The positional encoding 614 adds information about the position and structure of each frame in the sequence to the input embeddings received by the transformer encoder 616. Because the transformer encoder 616 processes the input embeddings in parallel, the positional encoding 614 advantageously provides context to the input embeddings that is used by the attention mechanism of the transformer encoder 616 to generate a denoised set of video frames 620. In some embodiments, the positional encoding is a sinusoidal positional encoding.

The transformer encoder 616 performs denoising diffusion over a plurality of timesteps by iteratively generating a denoised set of video frames that predict the motion at each timestep. In some embodiments, the transformer encoder 616 employs a Markov noising process

$${\{ {x}_{t}^{1 : N} \}}_{t = 0}^{T}$$

where

$${x}_{t}^{1 : N}$$

is drawn from the distribution data and the following equation is used to perform the diffusion process:

$$q ( {x}_{t}^{1 : N} \vert {x}_{t - 1}^{1 : N} ) = \text{?} ( \sqrt{{α}_{t}} {x}_{t}^{1 : N} , ( 1 - {α}_{t} ) I ) \qquad Eq . 1$$

where

$${x}_{t}^{1 : N}$$

represents the timesteps (t) from frames 1 to N, αₜ∈(0,1) are constant hyperparameters, [symbol] is a normal distribution, and I is the identity matrix indicating that the noise added to each dimension is independent and identically distributed. When αₜ is small enough,

$${x}_{i}^{1 : N} ∼ \text{?} ( 0 , I ) .$$

The diffusion process outputs video frames that over the plurality of timesteps become less incoherent (e.g., if the initial time step is 100 and the timestep count is decremented, the coherence increases as the timestep approaches 0). The transformer encoder 616 continues performing denoising diffusion over the timesteps until a termination criteria is met. In various embodiments, the termination criteria may include that a preset number of timesteps are completed, a change in video frames in consecutive timesteps are less than a threshold, and/or a compute budget is exhausted.

The output of the transformer encoder 616 is received by the second linear layer 618, which reduces the dimensionality of the denoised set of video frames (e.g., the output of the transformer encoder 616 includes vectors that are transformed into video frames) to match the dimensionality of the motion-identity data 604. In some embodiments, the second linear layer 618 acts as a shallow decoder to modify the dimensionality of the denoised set of video frames. The second linear layer 618 outputs the denoised set of video frames 620 numbering 1 to

$$N ( {\hat{x}}_{t}^{1} … {\hat{x}}_{t}^{N} ) .$$

In some embodiments, the denoised set of video frames 620 include keyframe poses and shape parameters. The shape parameters may be output as a shape vector. In some embodiments, the keyframe poses are also output as a motion vector. The shape parameters result in a character that matches the identity profile (provided as input) performing the requested motion. For this identity-aware model, the shape parameters are not as strictly enforced (e.g., the diffusion model 600 is not conditioned on the shape parameters) as they are for the other models (described below with reference to FIGS. 7 and 8).

In some embodiments, the graphics engine 108 may include an in-between module that generates in-between motion frames that illustrate a transition between the respective keyframe poses. In some embodiments, the in-between module implements a machine-learning model that performs interpolation to generate the in-between motion frames and/or performs in-painting to generate the in-between motion frames. Use of the in-between module can improve computational efficiency since the in-between motion frames may be generated cheaply (in comparison to computational cost of the motion diffusion model 600) and can enable a higher frame rate due to the availability of the in-between motion frames.

FIG. 7 is an architecture diagram that illustrates a motion diffusion model 700 to generate identity-conditioned motion generation, according to some embodiments. In this example, the motion content input and the identity profile are encoded independently of each other.

A first multilayer perceptron 706 receives timestep data 702 and motion data 704 that are converted into a timestep and motion embedding similar to the process described above with reference to FIG. 6.

A second multilayer perceptron 710 receives shape parameters (8) 708. The shape parameters 708 may be the same as an identity profile or extracted from an identity profile. The shape parameters may represent a fixed-length vector of coefficients associated with a parametric body model of the character. The shape parameters 708 are scalar values that are used to describe an amount of expansion or shrinkage of a human subject along some direction, such as taller or shorter to achieve a particular body shape. The shape parameters 708 may be multiplied by eigen vectors to obtain the particular body shape. In some embodiments, the shape parameters 708 are represented by a shape vector between 10 and 300 values where 10 may be used for general purposes and up to 300 values may be used for identifying minute variations.

The second multilayer perceptron 710 outputs a shape embedding that may be combined with the timestep and motion-identity embedding to form a shape, timestep, and motion-identity embedding 712 (Zₜₖ). In some embodiments, the shape, timestep, and motion-identity embedding 712 is generated by concatenating the shape embedding with the timestep and motion-identity embedding. In some embodiments, the shape, timestep, and motion-identity embedding 712 is generated by projecting the embeddings into a shared, different-dimensional space (e.g., low-dimensional space or high-dimensional space).

A first linear layer 716 receives a noise vector 714 as input from length 1 to N

$$( {x}_{t}^{1} ... {x}_{t}^{N} )$$

where N corresponds to the number of video frames to be output. In some embodiments, the noise vector 714 is sampled from a normal distribution (Gaussian distribution). The timesteps for the noise vector 714 correspond to the timestamps for the shape, timestep, and motion-identity embedding 712. In some embodiments, the noise vector 714 is a tensor that includes the number of joints, the number of degrees of freedom, and the number of timesteps.

The first linear layer 716 projects the noise vector 714 into a higher-dimensional embedding space for the transformer encoder 720 where the number of dimensions of the projected noise vector matches the number of dimensions for the shape, timestep, and motion-identity embedding 712. The output from the first linear layer 716 is combined with the output of the shape, timestep, and motion-identity embedding 712 at a conditioning injection point with a positional encoding 718 and provided as input to the transformer encoder 720. The positional encoding 718 adds information about the position and structure of each frame in the sequence to the input embeddings received by the transformer encoder 720. Because the transformer encoder 720 processes the input embeddings in parallel, the positional encoding 720 advantageously provides context to the input embeddings that is used by the attention mechanism of the transformer encoder 720 to generate a denoised set of video frames 724. In some embodiments, the positional encoding is a sinusoidal positional encoding.

The transformer encoder 720 performs denoising diffusion over a plurality of timesteps by iteratively generating a denoised set of video frames that predict the motion at each timestep. The diffusion process outputs video frames that increasingly become less incoherent as the timestep approaches 0. The transformer encoder 720 continues performing denoising diffusion until a termination criteria is met. The termination criteria may include that a preset number of timesteps are completed, a change in video frames in consecutive timesteps are less than a threshold, and/or a compute budget is exhausted.

The output of the transformer encoder 720 is received by the second linear layer 722, which reduces the dimensionality of the denoised set of video frames to match the dimensionality of the paired motion-identity data 704. In some embodiments, the second linear layer 722 acts as a shallow decoder to modify the dimensionality of the denoised set of video frames. The second linear layer 722 outputs the denoised set of video frames 724 numbering 1 to N

$$( {\hat{x}}_{t}^{1} ... {\hat{x}}_{t}^{N} ) .$$

As a result of adding the shape parameters, the denoised set of video frames 724 are conditioned on the shape parameters and the character in the denoised set of video frames 724 explicitly reflect the shape of the character.

FIG. 8 is an architecture diagram that illustrates a motion diffusion model 800 to generate identity-augmented motion, according to some embodiments. In some embodiments, the motion diffusion model 800 for identity-augmented motion includes a first diffusion model 804 and a second diffusion model 808. The first diffusion model 804 is trained on training data comprising shape parameters and the second diffusion model 808 is trained on training data comprising motion content input.

At inference time, the first diffusion model 804 receives shape parameters (8) 802 that correspond to a character. The first diffusion model 804 is conditioned on the shape parameters 802. The output from the first diffusion model 804 is received by the second diffusion model 808, which is conditioned on motion content input 806 that is requested by a user. For example, the motion content input 806 may include a video of a motion sequence of a person walking in a circle. The second diffusion model 808 combines the output from the first diffusion model 804 with the motion content input 806 to output a denoised set of video frames 810 that perform the motion identified in the motion content input 806 with the characteristics embodied by the shape parameters 802.

### Example Method

FIG. 9 is a flow diagram of a method 900 to generate identity-preserving motion, according to some embodiments. The method 900 may be performed by the graphics engine 108 in FIG. 1 and/or the computing device 200 in FIG. 2 and/or other component(s) usable in the network 122 of FIG. 1.

The method 900 may begin with block 902. At block 902 a motion content input that specifies a target motion sequence is obtained. The motion content may be text, audio, an image, and/or a video. The motion content input may include a natural language text prompt describing the target motion sequence. For example, the natural language text may include “jump to standing from a crouching position.” The motion content input may include a sequence of input keyframe poses corresponding to a reference motion of a reference character, wherein the reference character is different from the character associated with the identity profile. Block 902 may be followed by block 904.

At block 904, an identity profile associated with a character is obtained. Obtaining the identity profile may include receiving scalar input that specifies body shape parameters, receiving a body shape vector generated from a three-dimensional mesh of the character, receiving body shape parameters represented as a fixed-length vector of coefficients associated with a parametric body model of the character, or receiving a character description input that includes an image, a video, or a text description of the character that specifies one or more of demographic attributes, occupational attributes, and/or class-based attributes. In some embodiments, the identity profile includes semantic attributes extracted from one or more images or videos that depict the character. In some embodiments, the identity profile is encoded using a multilayer perceptron and provided as a conditioning input at individual timesteps of the plurality of timesteps.

In some embodiments, the motion content input and the identity profile are encoded independently of each other. In some embodiments, the motion content input that specifies the target motion sequence comprises a reference motion sequence of reference poses of a reference character depicting target motion, wherein the reference character is different from the character, performing the denoising diffusion process comprises identity-augmented motion generation, and the identity-preserving motion sequence includes a modification of the sequence of reference poses based on at least one physical or behavioral characteristic specified in the identity profile. Block 904 may be followed by block 906.

At block 906, a denoising diffusion process is performed using the motion content input and the identity profile over a plurality of timesteps using a motion diffusion model, where the denoising diffusion process is initiated using a noise vector and iteratively generates respective denoised sets of video frames for each timestep and where each video frame in a respective denoised set of video frames includes a respective pose of the character. In some embodiments, the motion diffusion model comprises a transformer encoder configured to process encoded poses, positional encodings, and identity profile representations. In some embodiments, the motion diffusion model is trained based on a training dataset of reference motions of reference characters and identity profiles for each of the reference characters. Block 906 may be followed by block 908.

At block 908, it is determined that a termination criteria for the denoising diffusion process is met at a particular timestep of the plurality of timesteps. Block 908 may be followed by block 910.

At block 910, responsive to determining that the termination criteria is met, a denoised set of video frames associated with the particular timestep are output as an identity-preserving motion sequence for the character, where the identity-preserving motion sequence depicts the character performing the target motion sequence.

In some embodiments, performing the denoising diffusion process comprises identity-aware motion generation, wherein the identity-preserving motion sequence is generated to reflect a specific movement associated with the identity profile while maintaining consistency with the motion content input. In some embodiments, performing the denoising diffusion process comprises identity-conditioned motion generation and wherein the identity-preserving motion sequence is synthesized as an interpretation of the natural language text prompt that is constrained by the identity profile. In some embodiments, performing the denoising diffusion process comprises identity-conditioned motion generation, wherein the identity-preserving motion sequence is synthesized as an interpretation of the natural language text prompt that is constrained by a latent identity representation of the identity profile associated with the character.

In some embodiments, respective poses in the denoised set of video frames are respective keyframe poses and the method further comprises generating in-between motion frames that illustrate a transition between the respective keyframe poses and combining the denoised set of video frames with the in-between motion frames.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods. Various blocks of the method 900 and/or other operations described herein may be combined, modified, omitted, supplemented with other operations, etc.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device 110 only; client+server device; etc.) and where the data analysis is performed (e.g., client device 110 only; client+server device; etc.). Data is utilized for the specific purposes as described herein. No data is shared with third parties without express user permission.

In the above description, for purposes of explanation, numerous specific details are set forth in order to provide a thorough understanding of the specification. The disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the segment “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are used by those of ordinary skill in the data processing arts to most effectively convey the substance of their work to others of ordinary skill in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing or for controlling performance of one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

1. A computer-implemented method comprising:
obtaining a motion content input that specifies a target motion sequence;
obtaining an identity profile associated with a character;
performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character;
determining that a termination criteria for the denoising diffusion process is met at a particular timestep of the plurality of timesteps; and
responsive to determining that the termination criteria is met, outputting a denoised set of video frames associated with the particular timestep as an identity-preserving motion sequence for the character, wherein the identity-preserving motion sequence depicts the character performing the target motion sequence.

2. The computer-implemented method of claim 1, wherein the motion content input comprises a natural language text prompt describing the target motion sequence.

3. The computer-implemented method of claim 2, wherein performing the denoising diffusion process comprises identity-aware motion generation, wherein the identity-preserving motion sequence is generated to reflect a specific movement associated with the identity profile while maintaining consistency with the motion content input.

4. The computer-implemented method of claim 2, wherein performing the denoising diffusion process comprises identity-conditioned motion generation and wherein the identity-preserving motion sequence is synthesized as an interpretation of the natural language text prompt that is constrained by the identity profile.

5. The computer-implemented method of claim 2, wherein performing the denoising diffusion process comprises identity-conditioned motion generation, wherein the identity-preserving motion sequence is synthesized as an interpretation of the natural language text prompt that is constrained by a latent identity representation of the identity profile associated with the character.

6. The computer-implemented method of claim 1, wherein the motion content input comprises a sequence of input keyframe poses corresponding to a reference motion of a reference character, wherein the reference character is different from the character associated with the identity profile.

7. The computer-implemented method of claim 1, wherein obtaining the identity profile includes receiving scalar input that specifies body shape parameters, receiving a body shape vector generated from a three-dimensional mesh of the character, receiving body shape parameters represented as a fixed-length vector of coefficients associated with a parametric body model of the character, or receiving a character description input that includes an image, a video, or a text description of the character that specifies one or more of demographic attributes, occupational attributes, class-based attributes, and combinations thereof.

8. The computer-implemented method of claim 1, wherein the identity profile comprises semantic attributes extracted from one or more images or videos that depict the character.

9. The computer-implemented method of claim 1, wherein the motion diffusion model comprises a transformer encoder configured to process encoded poses, positional encodings, and identity profile representations.

10. The computer-implemented method of claim 1, wherein the identity profile is encoded using a multilayer perceptron (MLP) and provided as a conditioning input at individual timesteps of the plurality of timesteps.

11. The computer-implemented method of claim 1, wherein respective poses in the denoised set of video frames are respective keyframe poses, the method further comprising:
generating in-between motion frames that illustrate a transition between the respective keyframe poses; and
combining the denoised set of video frames with the in-between motion frames.

12. The computer-implemented method of claim 1, wherein the motion content input and the identity profile are encoded independently of each other.

13. The computer-implemented method of claim 1, wherein:
the motion content input that specifies the target motion sequence comprises a reference motion sequence of reference poses of a reference character depicting target motion, wherein the reference character is different from the character;
performing the denoising diffusion process comprises identity-augmented motion generation; and
the identity-preserving motion sequence includes a modification of the sequence of reference poses based on at least one physical or behavioral characteristic specified in the identity profile.

14. The computer-implemented method of claim 1, wherein the motion diffusion model is trained based on a training dataset of reference motions of reference characters and identity profiles for each of the reference characters.

15. A system comprising:
one or more processors; and
a memory coupled to the one or more processors, with instructions stored thereon that, when executed by the one or more processors, cause the one or more processors to perform or control performance of operations comprising:
obtaining a motion content input that specifies a target motion sequence;
obtaining an identity profile associated with a character;
performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character;
determining that a termination criteria for the denoising diffusion process is met at a particular timestep of the plurality of timesteps; and
responsive to determining that the termination criteria is met, outputting a denoised set of video frames associated with the particular timestep as an identity-preserving motion sequence for the character, wherein the identity-preserving motion sequence depicts the character performing the target motion sequence.

16. The system of claim 15, wherein the motion content input comprises a natural language text prompt describing the target motion sequence.

17. The system of claim 16, wherein performing the denoising diffusion process comprises identity-aware motion generation, wherein the identity-preserving motion sequence is generated to reflect a specific movement associated with the identity profile while maintaining consistency with the motion content input.

18. A non-transitory computer-readable medium with instructions stored thereon that, when executed by one or more computers, cause the one or more computers to perform or control performance of operations, the operations comprising:
obtaining a motion content input that specifies a target motion sequence;
obtaining an identity profile associated with a character;
performing, using the motion content input and the identity profile, a denoising diffusion process over a plurality of timesteps using a motion diffusion model, wherein the denoising diffusion process is initiated using a noise vector and iteratively generates respective denoised sets of video frames for each timestep and wherein each video frame in a respective denoised set of video frames includes a respective pose of the character;
determining that a termination criteria for the denoising diffusion process is met at a particular timestep of the plurality of timesteps; and
responsive to determining that the termination criteria is met, outputting a denoised set of video frames associated with the particular timestep as an identity-preserving motion sequence for the character, wherein the identity-preserving motion sequence depicts the character performing the target motion sequence.

19. The computer-readable medium of claim 18, wherein the motion content input comprises a natural language text prompt describing the target motion sequence.

20. The computer-readable medium of claim 19, wherein performing the denoising diffusion process comprises identity-aware motion generation, wherein the identity-preserving motion sequence is generated to reflect a specific movement associated with the identity profile while maintaining consistency with the motion content input.
